(19) United States
(12) Patent Application Publication
(10) Pub. No.: US 2012/0002674 A1
(43) Pub. Date: Jan. 5, 2012

(54) Communication System and Server Unit Thereof

(76) Inventor: Hideto Murakami, Machida-shi (JP)

(21) Appl. No.: 13/233,980

(22) Filed: Sep. 15, 2011

Related U.S. Application Data
(63) Continuation of application No. 12/721,401, filed on Mar. 10, 2010.

(30) Foreign Application Priority Data
Jun. 30, 2009 (JP) 2009-155999

(51) Int. Cl. H04L 12/56

(52) U.S. Cl. 370/392

(57) ABSTRACT

According to one embodiment, there is provided a communication system including at least a router and a server. The router interconnects a private network using private address and a global network using global address. The router has a network address translation (NAT) function for converting the private address into the global address and for converting the global address into the private address. The server unit is coupled to the global network and executes processing based on Session Initiation Protocol (SIP) messages output from a terminal via the router. One type of SIP message is a REGISTER message, where the router adds a Via header containing an Internet Protocol (IP) address of the router to the REGISTER message for designating a transmission route for use in a registration process.

### CROSS-REFERENCE TO RELATED APPLICATIONS

This application is a continuation application of U.S. patent application Ser. No. 12/721,401, which is based upon and claims the benefit of priority from Japanese Patent Application No. 2009-155999, filed Jun. 30, 2009, the entire contents of which are incorporated herein by reference.

### BACKGROUND

1. Field

One embodiment of the present invention relates to a communication system which can exchange media data between terminals via an Internet Protocol (IP) network, and a server unit used in this system.

2. Description of the Related Art

In recent IP communication systems, Session Initiation Protocol (SIP), H.323, Media gateway control (Megaco), and the like are known as protocols that form end-to-end sessions between terminals. In recent years, the SIP is prevalently used.

The basic specification of the SIP is described in RFC 3261 formulated by the Internet Engineering Task Force (IETF). In addition, the SIP extended version and various related specifications have been formulated. For example, RFC 2663 describes the specification of Network Address Port Translation (NAPT) as an address conversion protocol.

In order to implement various communication services using the SIP, the procedures for registering a SIP terminal which joins a network in a SIP server are required. In these procedures, a SIP terminal transmits a registration request message (REGISTER) to a SIP server. The SIP server binds a SIP-Uniform Resource Identifier (SIP-URI) to be registered included in the received REGISTER message and the address (notified using a Contact header) of the SIP terminal as a request source, and records them in a database. Note that the SIP-URI to be registered is a logical address called an Address of Record (AoR), and an actual address of the SIP terminal is called a contact address.

Upon completion of this processing, a SIP message transmitted and addressed to the AoR is transferred from the SIP server to the contact address bound to this AoR. For this reason, in order to discriminate a terminal which uses an AoR, a contact address is normally used.

In discriminating a terminal using an AoR by a contact address, a problem is posed in a network which includes the aforementioned NAPT function or Network Address Translation (NAT) function. That is, when a SIP message passes through a communication apparatus having the NAT function (to be referred to as, for example, a NAT router hereinafter), a contact address contained in that message is replaced by global address of the NAT router. That is, since all the contact addresses of SIP terminals which belong to a private network under the NAT router are converted into an identical IP address, a terminal itself as an output source of the REGISTER message cannot be distinguished.

This also leads to the following problem. For example, in case of providing a paid SIP service, password authentication is executed to authenticate a user. However, since the system cannot discriminate each individual terminal, if a malicious user leaks a password, an unauthorized user can also receive the service.

In order to prevent illicit use by a user, a technique of Jpn. Pat. Appin. KOKAI Publication No. 2008-78766 is known. In this reference, by adding information used to specify a user to a REGISTER message, a user of each individual SIP terminal is allowed to be specified. However, a SIP terminal has to be uniquely altered. In particular, since a user is to be discriminated using position information acquired from a HUB, usable SIP terminals are limited, and the versatility is low. A method which can solve the above problem within the specification of RFC 3261 as the basic specification is demanded.

As described above, with the existing techniques, a SIP server cannot discriminate a SIP terminal which belongs to a private network under a NAT device. For this reason, since a problem in terms of accounting occurs, measures of some sort are required.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system diagram showing an embodiment of a communication system according to the invention;

FIG. 2 is a functional block diagram showing an embodiment of a SIP server 200 shown in FIG. 1;

FIG. 3 is a block diagram showing the relationship among software modules included in the SIP server 200 shown in FIG. 2;

FIG. 4 is a view showing an example of a REGISTER message;

FIG. 5 is a view showing an example of a location table 24a shown in FIGS. 2 and 3;

FIG. 6 is a flowchart showing the processing sequence which is executed by a registration decision module 23b to decide whether or not to permit registration;

FIG. 7 is a view for explaining the generation sequence of discrimination information according to the second embodiment; and

FIG. 8 is a block diagram showing the software configuration in a case in which a location server is arranged.

### DETAILED DESCRIPTION

Various embodiments according to the invention will be described hereinafter with reference to the accompanying drawings. In general, according to one embodiment of the invention, there is provided a communication system comprising a router, a terminal and a server unit. The router interconnects a private network using private address and a global network using global address. The terminal belongs to the private network. The server unit is connected to the global network and executes processing based on Session Initiation Protocol (SIP) messages output from the terminal via the router. The server unit comprises a discrimination information generator, a management table and a registration decision module. The discrimination information generator generates discrimination information to be associated with a transmission source terminal of a REGISTER message from Internet Protocol (IP) addresses contained in all Via headers, which are sequentially added by devices in a route including the router, in the REGISTER message, which is received from the terminal via the route. The management table associates the discrimination information with a registration condition of the terminal which belongs to the private network for each terminal. The registration decision module collates the discrimination information and the registration condition managed in the management table. The registration decision module decides based on the collation result whether or not to permit registration of a terminal as a registration request source using the REGISTER message.

By taking such means, when a REGISTER message reaches a server unit, discrimination information is generated based on IP addresses contained in all of a plurality of Via headers included in this message. The IP addresses in the Via headers uniquely reflect the transmission route of the REGISTER message. Hence, using this discrimination information, respective transmission routes can be uniquely discriminated. That is, a SIP terminal as an output source of the REGISTER message can be uniquely discriminated.

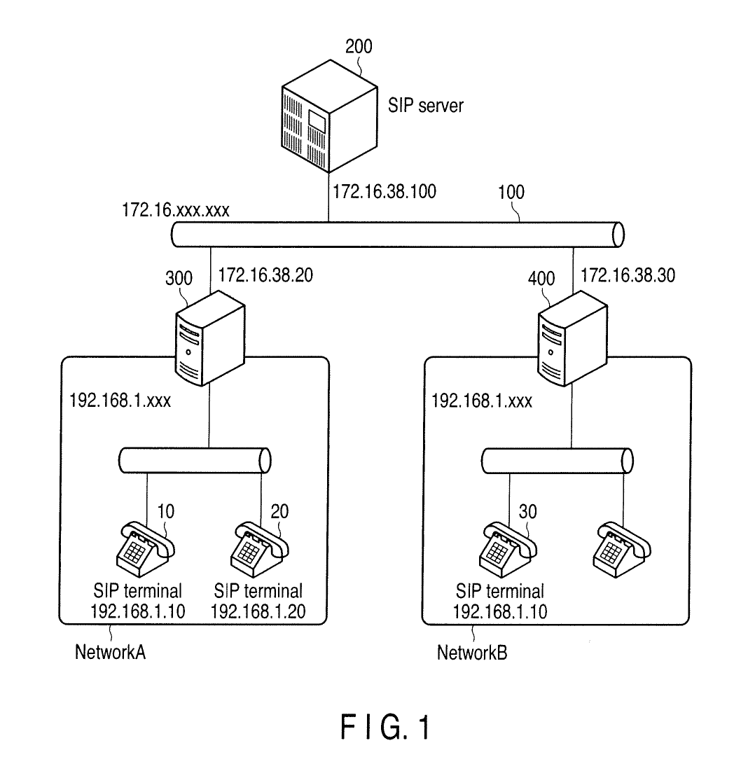

FIG. 1 is a system diagram showing an embodiment of a communication system according to the invention. This communication system is formed by an IP network as a backbone network 100 and a SIP server 200 connected to this backbone network as a core. The SIP server 200 has a function as a proxy server which relays a SIP message, and a function as a registrar server which manages location information of SIP terminals.

Routers 300 and 400 are connected to the backbone network 100. The router 300 connects network A as a private network to the backbone network 100. The router 400 connects network B as a private network to the backbone network 100.

The backbone network 100 is an IP network using global address, and is used as, for example, a public network. Private networks A and B are networks that use private addresses, and use IP addresses assigned by a management architecture different from the backbone network 100.

Both the routers 300 and 400 include a NAT function, and a NAT solution function that guarantees transmission of a SIP message under this NAT function. The NAT function converts the private address used in the private network into the global address of each router, and vice versa. This function is required to solve the current IPv4 address shortage.

By providing the NAT function to the router, a difference between the IP address management architectures in the global network and private network can be solved, and the system can be managed without causing any problems such as duplicate addresses. However, since the NAT function basically converts an IP address included in a header of an IP packet, it cannot convert an IP address embedded in a SIP message. Hence, a system using the SIP requires the NAT solution function.

The NAT solution function includes, for example, Application Level Gateway (ALG). ALG is a method of interpreting the contents of a SIP message which passes through a NAT/NAPT router, and replacing the private address embedded in the SIP message by the global address of the NAT/NAPT router. Since the IP address in the SIP message is replaced in the router, a function that supports ALG need not be implemented in the SIP terminal.

That is, the routers 300 and 400 serve as both a NAT router function and ALG server function. The global address of the router 300 is “172.16.38.20”, and that of the router 400 is “172.16.38.30”.

Note that the NAT solution function includes a function called Simple Traversal of UDP through NAT (STUN) or Traversal Using Relay NAT (TURN) in addition to ALG. STUN is a protocol specified by RFC 3489, and includes the following procedures. A SIP terminal applied to STUN transmits a packet including the self IP address and port number to a STUN server connected to a global network. The STUN server compares information of a header with that of a data field of the received packet to detect the IP address and port number of the SIP terminal in the course of NAT processing. The STUN server notifies the SIP terminal as a transmission source of these pieces of information, and the SIP terminal can detect address information on the global network side. Based on this address information, the SIP terminal can include the global address used in the global network in a SIP message, thus implementing the NAT solution.

In TURN, an apparatus used to relay media data (TURN server) is arranged on the global network side. TURN is a protocol that allows to exchange a packet via a NAT router by exchanging a packet between the private network and global network temporarily via a TURN server.

SIP terminals 10 and 20 belong to private network A, and a SIP terminal 30 belongs to private network B. All of these SIP terminals have uniquely set URIs. A SIP service is provided basically using this URI (to be referred to as a primary URI hereinafter).

For example, the IP address of the SIP terminal 10 in private network A is “192.168.1.10”, and that of the SIP terminal 20 is “192.168.1.20”. The URIs of the respective terminals are set based on these IP addresses. The IP address of the SIP terminal 30 in private network B is “192.168.1.10”, and is the same as that of the SIP terminal 10, but it is hidden by the NAT function of the router 400. As for the AoR, assume that a plurality of SIP terminals never simultaneously use an identical AoR in principle.

When one SIP terminal uses a plurality of URIs, URIs other than the primary URI are called secondary URIs. The secondary URIs are managed in association with the primary URI. Note that the primary URI and secondary URIs are concepts used for the purpose of easy understanding of characteristic features of the invention in the following description.

In FIG. 1, the SIP server 200 serves as a registrar server and proxy server for the SIP terminals 10, 20, and 30. Hence, the SIP terminal 10 transmits a REGISTER message to the SIP server 200 at a service start timing, and requests the server to register itself in the system.

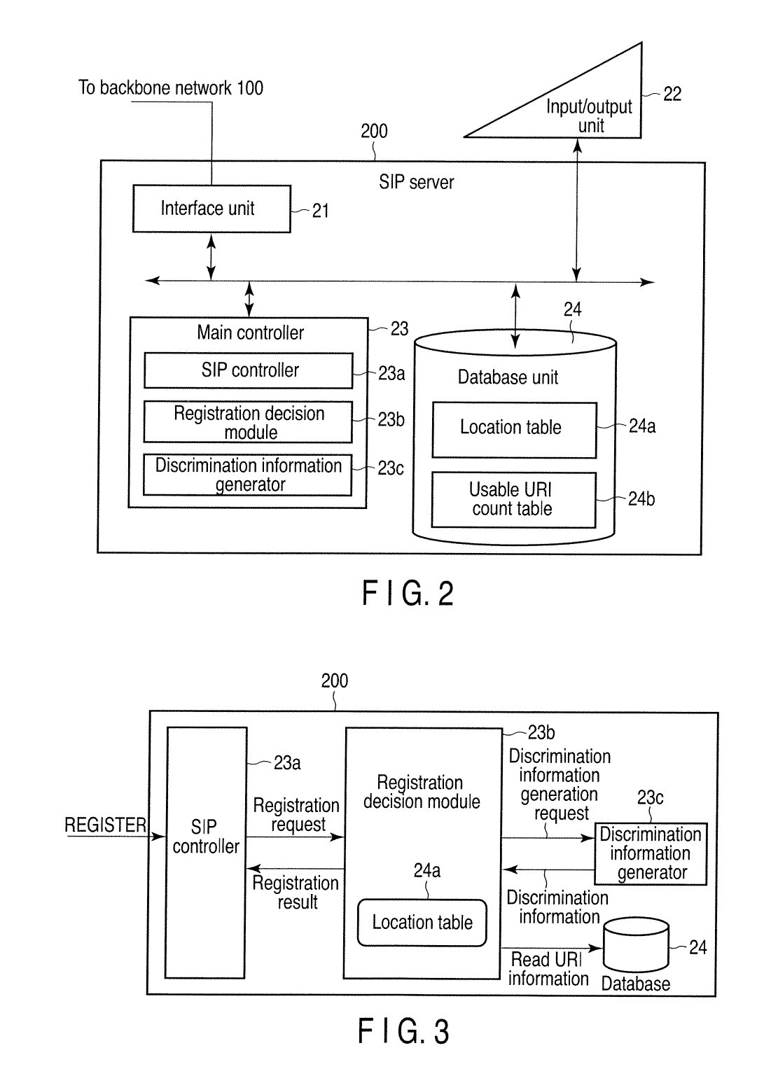

FIG. 2 is a functional block diagram showing an embodiment of the SIP server 200 shown in FIG. 1. The SIP server 200 includes an interface unit 21, input/output unit 22, main controller 23, and database unit 24. The interface unit 21 is connected to the backbone network 100, and executes interface processing associated with packet exchanges. The input/output unit 22 is used to, e.g., input various setting data and management information.

The main controller 23 includes a SIP controller 23a, registration decision module 23b, and discrimination information generator 23c as processing functions according to this embodiment.

The SIP controller 23a interprets a SIP message received from each SIP terminal via the router 300 or 400, and controls, e.g., call connection processing according to the contents of the message. The registration decision module 23b decides whether or not to permit registration of the SIP terminal which requested registration using the REGISTER message, with reference to a location table 24a stored in the database unit 24.

The discrimination information generator 23c generates discrimination information used to discriminate each SIP terminal from IP addresses contained in all Via headers of the REGISTER message received from that SIP terminal via the router 300 or 400. Furthermore, the database unit 24 stores a usable URI count management table 24b . This table is used to manage URI entities and the number of usable URIs per SIP terminal.

FIG. 3 is a block diagram showing the relationship among software modules included in the SIP server shown in FIG. 2. On receiving a registration request using a REGISTER message, the SIP controller 23a requests the registration decision module 23b to decide whether or not to permit that registration. The registration decision module 23b decides whether or not to permit registration with reference to the location table 24a . The registration decision module 23b requests the discrimination information generator 23c to generate discrimination information used to discriminate each SIP terminal. In response to this request, the discrimination information generator 23c generates discrimination information associated with a transmission source terminal of the received REGISTER message from IP addresses contained in all Via headers in this REGISTER message.

In FIG. 3, a SIP message that reaches the SIP server 200 is processed by the SIP controller 23a first. If this SIP message is a REGISTER message, the SIP controller 23a notifies the registration decision module 23b of the message. The registration decision module 23b decides whether or not to permit registration of the SIP terminal as an output source of this REGISTER message. If registration is permitted, the registration decision module 23b associates (binds) an AoR and contact address notified by this REGISTER message.

The registration decision module 23b transmits a discrimination information generation request to the discrimination information generator 23c to generate information used to discriminate the transmission source terminal of the REGISTER message. In this discrimination information generation request, all Via headers included in the received REGISTER message are set.

The discrimination information generator 23c extracts only IP addresses from the Via headers notified by the discrimination information generation request. The IP addresses extracted from all the Via headers are concatenated into a character string of one line, and discrimination information is generated from this character string. The generated discrimination information is returned to the registration decision module 23b as a request source as the discrimination information generation result. The generated discrimination information is registered in the location table 24a . The location table 24a also manages the bound AoR and contact address.

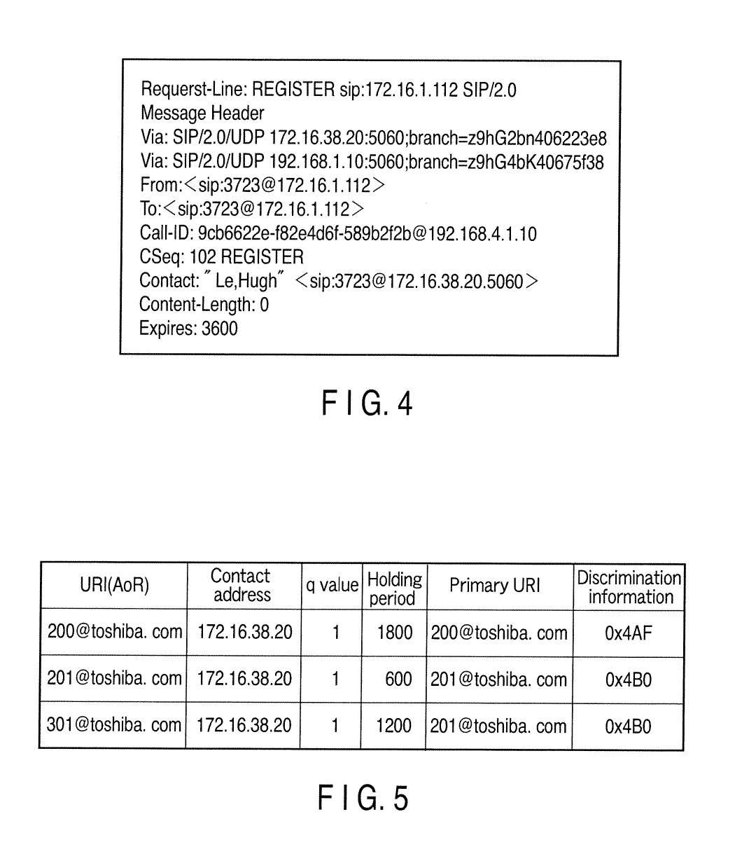

FIG. 4 shows an example of a REGISTER message. This message has a basic format specified by RFC 3261. According to the SIP specification, the IP address “192.168.1.10” of the SIP terminal 10 as a registration request source is set in a Contact header and Via header in the REGISTER message. When this REGISTER message is output from the SIP terminal 10 and then goes through the router 300, the ALG function of the router 300 modifies a part of the description of that REGISTER message. That is, the contact address in the Contact header in the REGISTER message is rewritten by “172.16.38.20”.

The first embodiment focuses attention on Via headers contained in the third and fourth lines from the top of the message. As is well known, the Via headers include information indicating a route through which a SIP message passed. In the Via headers, the IP addresses of devices (SIP-Proxy) in a passing route of the SIP message are sequentially added. In FIG. 4, the Via header in the fourth line contains the IP address “192.168.1.10”, and that in the third line contains the IP address “172.16.38.20”. This indicates that this REGISTER message was output from the SIP terminal 10, and reached the SIP server 200 via the router 300.

The discrimination information generator 23c combines these IP addresses to generate discrimination information used to discriminate the SIP terminal. In order to generate the discrimination information, a checksum based a concatenated character string or a hash function such as MD5/SHA can be used. For example, in an example using a checksum, digits of the respective IP addresses are concatenated to generate a character string “172.16.38.20192.168.1.10”, which is simply added to generate discrimination information using the checksum. More specifically, the concatenated character string “172.16.38.20192.168.1.10” is simply added as “0x31+0x37+0x32+ . . . +0x31+0x30”, thus generating discrimination information “0X4AF”.

That is, the character string is expressed by ASCII codes, and the IP address “172.16.38.20” notified by the SIP message is expressed by, e.g., binary codes “0x31, 0x37, 0x32, 0x2E, 0x31, 0x36, 0x2E, 0x33, 0x38, 0x2E, 0x32, 0x30”. By adding these binary data intact, a checksum can be generated at high speed. The need for converting character codes is obviated, and the processing can be further speeded up accordingly.

FIG. 5 shows an example of the location table 24a shown in FIGS. 2 and 3. In the location table 24a, information such as the contact address to the SIP terminal as a REGISTER message output source, a q value, and holding period are registered to have the AoR of the SIP terminal to be registered as key information. These pieces of information are required for binding defined by RFC 3261. In addition, in this embodiment, a primary URI of the SIP terminal and the generated discrimination information are registered. The operation in the above arrangement will be described below.

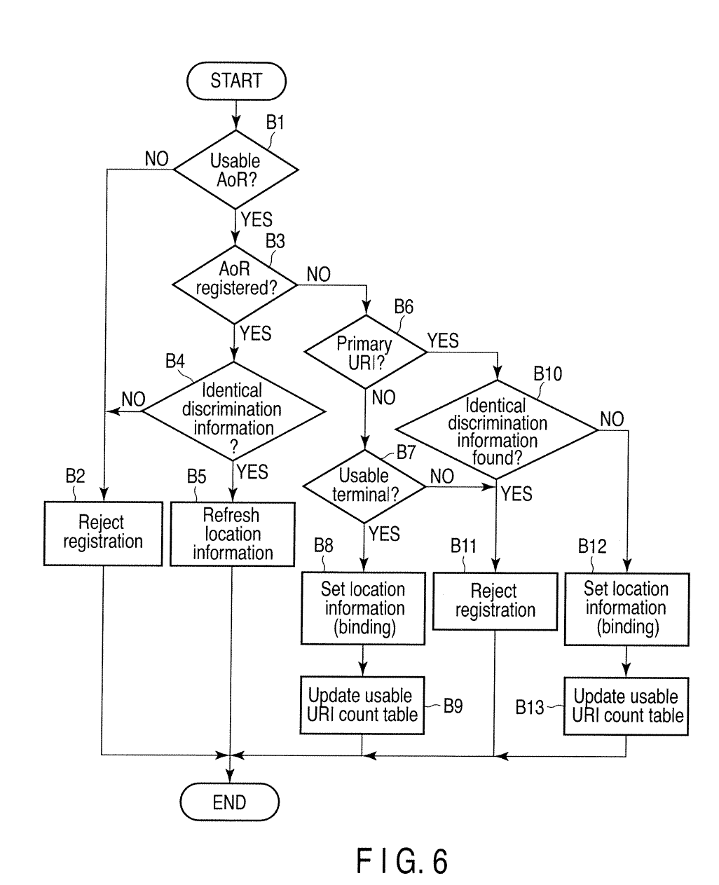

FIG. 6 is a flowchart showing the processing sequence which is executed by the registration decision module 23b to decide whether or not to permit registration. On receiving a REGISTER message from a SIP terminal which requests registration in the system, the registration decision module 23b checks if an AoR contained in this message is usable (block B1). If the AoR is unusable, the registration decision module 23b rejects registration (block B2).

The registration decision module 23b then checks if the contained AoR is registered in the location table 24a (block B3). If the location table 24a stores the AoR to be decided, the registration decision module 23b decides if discrimination information generated by the discrimination information generator 23c after receiving the REGISTER message is the same as that in the location table (block B4). If the two pieces of discrimination information match, the registration decision module 23b determines to refresh binding (block B5), updates the holding period of the corresponding record in the location table 24a, and notifies the SIP controller 23a of the normal termination of the processing. If the two pieces of discrimination information do not match, the registration decision module 23b determines an illicit registration request, and rejects registration.

If NO in block B3, i.e., if the notified AoR is not registered, processing as first registration is started. That is, the registration decision module 23b decides with reference to the usable URI count management table 24b whether or not the AoR in the received REGISTER message is a primary URI (block B6). If the AoR is the primary URI, the registration decision module 23b confirms if the location table 24a includes a record having the same discrimination information (block B10). If the location table 24a includes a record having the same discrimination information, the registration decision module 23b rejects registration (block B11). With this sequence, the primary URI that can be used in one terminal is limited to one. Note that use of a plurality of primary URIs is assumed depending on system requests.

If the location table 24a does not include any record having the same discrimination information in block B10, the registration decision module 23b determines first registration of a primary URI. Then, the registration decision module 23b registers notified information and discrimination information in the location table 24a, and binds the AoR and contact address (block B12). If the notified AoR is a secondary URI, the registration decision module 23b updates the usable URI count table 24b, and executes registration processing as the secondary URI (block B13). With the aforementioned sequence, the SIP terminal which uses a URI can be physically discriminated and specified.

As described above, according to this embodiment, when a REGISTER message reaches the SIP server 200 via the router having the NAT function, the discrimination information generator 23c of the SIP server 200 extracts IP addresses from all Via headers of the received REGISTER message. The discrimination information generator 23c registers a checksum, which is generated by coupling character strings of these IP addresses, and simply adding the obtained numeric string, in the location table 24a as discrimination information. The discrimination information may use data obtained by coupling the extracted IP addresses intact or may use a hash value generated from the IP addresses using a hash function. Alternatively, character string information obtained by simply coupling the IP addresses may be used as discrimination information. Furthermore, information obtained by partially extracting the Via headers including the IP addresses may be used. In short, information that can be uniquely discriminated need only be generated from the IP addresses of all the Via headers.

The registration decision module 23b decides whether or not to permit registration of the SIP terminal as the REGISTER output source with reference to the location table 24a which stores the generated discrimination information and already registered URI information, and the usable URI count management table 24b in which the number of URIs usable by each SIP terminal is set.

Since the IP addresses contained in the Via headers uniquely indicate a route via which the REGISTER message was transmitted, each individual SIP terminal can be physically discriminated using discrimination information generated from all the IP addresses. Therefore, this discrimination information can be uniquely associated with each SIP terminal, and a plurality of SIP terminals which belong to the private networks can be individually discriminated based on the discrimination information.

Therefore, one URI is surely associated with one SIP terminal, and a SIP terminal which is not associated can be inhibited from using that URI at the same time. In an accounting system using a URI as a unit, illicit use of URIs can be prevented. Furthermore, the number of REGISTER messages from an identical SIP terminal is limited to a given value, and an overload measure of the SIP server 200 can be promoted.

According to the aforementioned sequence, no unique function is required to be added to a SIP terminal, and the number of URIs that can be used by one SIP terminal or the number of SIP terminals that can simultaneously use one URI can be surely controlled by fewer comparison processes.

In this embodiment, all Via headers appended every time SIP-Proxy is relayed are referred to. In this way, this embodiment can cope with a case in which there are a plurality of private networks that require NAT traversal. That is, this is the case when a plurality of SIP terminals have a duplicate private address like the SIP terminals 10 and 30 in FIG. 1. Hence, by referring to the IP addresses in all Via headers, each individual SIP terminal can be physically discriminated as well as discrimination of the private networks.

Furthermore, since a Via header is appended every time a message goes through multi-stage SIP-Proxy, the data amount used to generate discrimination information increases. In this embodiment, since a checksum generated from the concatenated IP addresses is used as discrimination information, the data amount can be reduced, thus reducing the capacity required for a processing memory and preventing an increase in cost of the system. In addition, the same effect can be obtained when a hash value based on the hash function is used.

### Second Embodiment

The first embodiment assumed the case in which the NAT functions in the routers 300 and 400 are solved by ALG. In such case, discrimination information for each SIP terminal can be generated using only Via headers in a REGISTER message. This is because IP addresses in request source lines of REGISTER messages are different for respective segments (private networks).

By contrast, in the aforementioned case in which a NAT problem is solved by STUN or TURN, the IP addresses of request source lines in Via headers become the same in all segments. An embodiment that assumes such case will be described below.

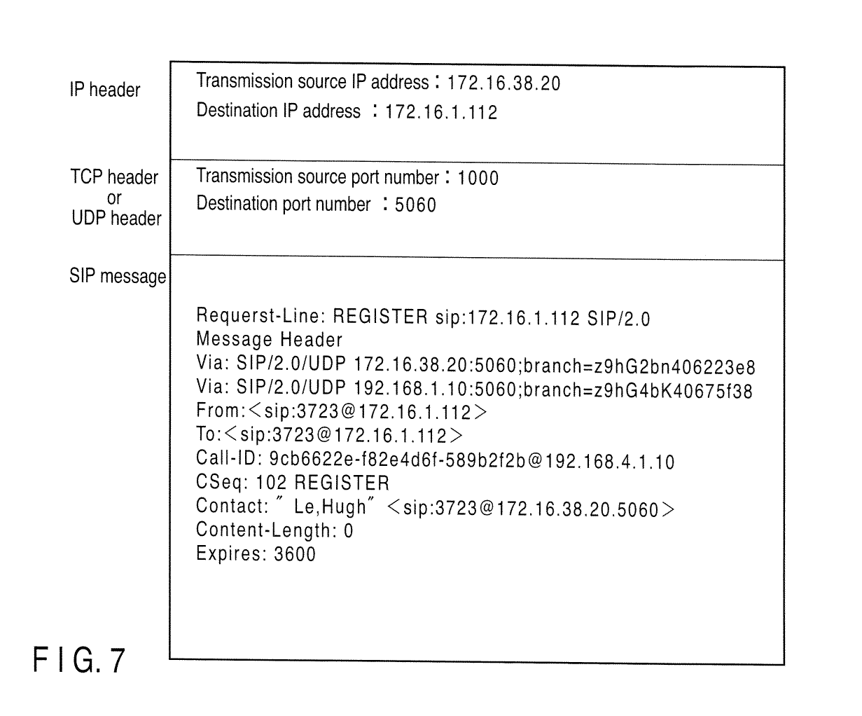

FIG. 7 is a view for explaining the generation sequence of discrimination information in this embodiment. That is, this embodiment uses an IP header and UDP/TCP header contained in an IP packet used to transmit a REGISTER message in addition to IP addresses contained in Via headers in this REGISTER message.

As shown in FIG. 7, an IP packet used to transmit a SIP message contains transmission source and destination IP addresses in its IP header. Also, a TCP or UDP header contains transmission source and destination port numbers. According to FIG. 7, a Via header in the third line of the SIP message contains an IP address “172.16.38.20”, and a Via header in the fourth line contains an IP address “192.168.1.10”. Furthermore, the transmission source port number in the TCP/UDP header contains “1000”, and the transmission source IP address in the IP header contains “172.16.38.20”.

Hence, in this embodiment, these IP addresses and port number are combined to generate a character string “172.16.38.20192.168.1.10172.16.38.201000”, and to simply add this, thereby generating a checksum. That is, in the second embodiment, the method used in the first embodiment is expanded, and a checksum is generated using a transmission source IP address in an IP header and a transmission source port number included in a UDP/TCP header of an IP packet used to carry a REGISTER message in addition to IP addresses in Via headers. By using this checksum as discrimination information, even in a system in which a NAT problem is solved by a method other than ALG (e.g., STUN or TURN), a SIP terminal as a REGISTER message output source can be individually discriminated.

Note that the invention is not limited to the above embodiments. For example, a location server used to manage the locations of SIP terminals may be used.

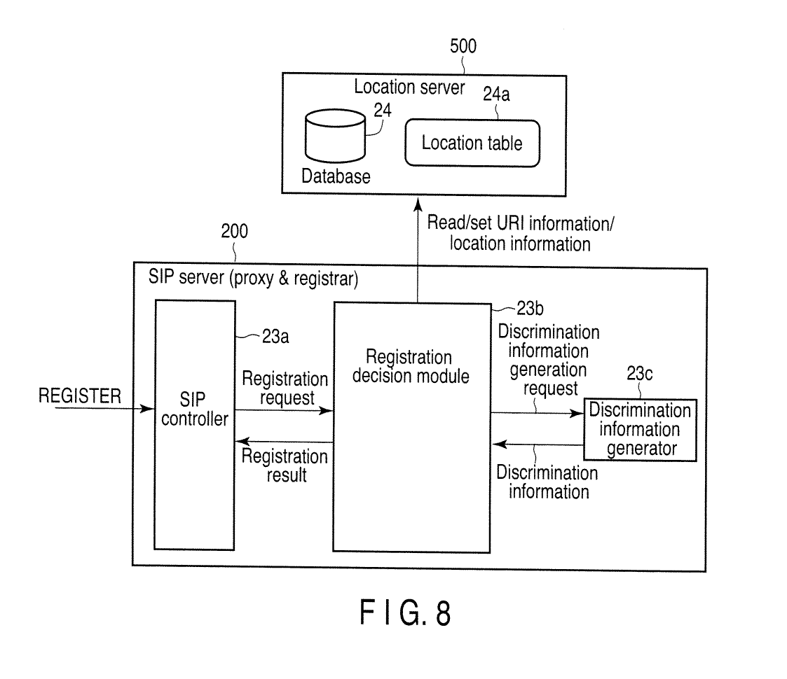

FIG. 8 is a block diagram showing the software configuration in a case in which a location server is arranged. A location server 500 is arranged independently of the SIP server 200. The location server 500 stores a location table 24a and usable URI count table 24b in a database 24. With this configuration, when a plurality of SIP servers are connected, the integrity of location information to be referred to by each SIP server can be improved. That is, when the plurality of SIP servers store location tables, these location tables have to be synchronized. By unifying the database, as shown in FIG. 8, since the need for the synchronization processing among databases can be obviated, data to be referred to by the registration decision module 23b can be unified.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising:
a router configured to interconnect a private network using private address and a global network using global address, the router including a network address translation (NAT) function for converting the private address into the global address and for converting the global address into the private address;
a plurality of terminals belonging to the private network; and
a server unit coupled to the global network and configured to execute processing based on Session Initiation Protocol (SIP) messages output from the plurality of terminals via the router, the server unit comprises:
a discrimination information generator configured to generate discrimination information to be associated with a transmission source terminal included in the plurality of terminals, which transmits a REGISTER message via a router where the router is present, by using all Internet Protocol (IP) addresses respectively contained in all Via headers, which are sequentially added to the REGISTER message by devices located in a route;
a management table configured to associate a predetermined registration condition containing the discrimination information and the number of usable Uniform Resource Identifiers with each terminal which belongs to the private network; and
a registration decision module configured to collate the discrimination information and the registration condition managed in the management table and to decide based on the collation result whether or not to permit the transmission source terminal to be registered.

2. The communication system of claim 1, wherein the discrimination information generator uses, as the discrimination information, a checksum generated from character information obtained by coupling the IP addresses contained in all the Via headers in the REGISTER message.

3. The communication system of claim 1, wherein the discrimination information generator uses, as the discrimination information, a hash value generated using a hash function from the IP addresses contained in all the Via headers in the REGISTER message.

4. The communication system of claim 1, wherein the discrimination information generator generates the discrimination information by further combining a transmission source IP address contained in an IP header of an IP packet used to transmit the received REGISTER message and a transmission source port number contained in a transmission control protocol/user datagram protocol (TCP/UDP) header of that IP packet with the IP addresses contained in all the Via headers.

5. The communication system of claim 1, wherein the registration decision module identifies each of the plurality of terminals when said each terminal starts communication based on the management table.

6. The communication system of claim 1, wherein the registration decision module decides whether or not to permit the transmission source terminal to be registered based on an uniform resource indicator (URI) in the REGISTER MESSAGE and terminal register information stored in the management table.

7. Coupled to a global network in a communication system comprising a plurality of terminals belonging to a private network and a router that interconnects the private network using private address and the global network using global address by use of a network address translation (NAT) function that converts the private address into the global address and the global address into the private address, a server unit comprising:
a Session Initiation Protocol (SIP) controller configured to execute processing based on input SIP messages via the router;
a discrimination information generator configured to generate discrimination information to be associated with a transmission source terminal of the plurality of terminals that transmits a REGISTER message via a transmission route including the router by use of Internet Protocol (IP) addresses contained in Via headers of the REGISTER messages, the IP addresses are sequentially added by devices in the transmission route;
a management table configured to associate a predetermined registration condition containing the discrimination information and a number of usable Uniform Resource Identifiers with each terminal belonging to the private network; and
a registration decision module configured to collate the discrimination information and the registration condition managed in the management table and to determine, based on a result of the collation, whether or not to permit the transmission source terminal to be registered.

8. The server unit of claim 7, wherein the input SIP messages are output from the plurality of terminals via the router.

9. The server unit of claim 7, wherein the discrimination information generator transmits the REGISTER message via the transmission route using all IP addresses respectively contained in all Via headers of the REGISTER message.

10. The server unit of claim 7, wherein the discrimination information generator uses, as the discrimination information, a checksum generated from character information obtained by coupling the IP addresses contained in all the Via headers in the REGISTER message.

11. The server unit of claim 7, wherein the discrimination information generator uses, as the discrimination information, a hash value generated using a hash function from the IP addresses contained in all the Via headers in the REGISTER message.

12. The server unit of claim 7, wherein the discrimination information generator generates the discrimination information by further combining a transmission source IP address contained in an IP header of an IP packet used to transmit the received REGISTER message and a transmission source port number contained in a transmission control protocol/user datagram protocol (TCP/UDP) header of that IP packet with the IP addresses contained in all the Via headers.

13. The server unit of claim 7, wherein the registration decision module identifies each of the plurality of terminals when said each terminal starts communication based on the management table.

14. The server unit of claim 7, wherein the registration decision module decides whether or not to permit the transmission source terminal to be registered based on an uniform resource indicator (URI) in the REGISTER MESSAGE and terminal register information stored in the management table.

15. A communication system comprising:
a router which interconnects a private network using private address and a global network using global address, the router having a network address translation (NAT) function for converting the private address into the global address and for converting the global address into the private address;
a server unit which is connected to the global network and executes processing based on Session Initiation Protocol (SIP) messages output from a terminal via the router,
wherein the router comprises means for adding a Via header containing an Internet Protocol (IP) address of the router to a REGISTER message.

16. The communication system of claim 15, wherein the REGISTER message including a plurality of Via headers to reflect a transmission route of the REGISTER message.
